(19) United States
(12) Patent Application Publication
(10) Pub. No.: US 2004/0243716 A1
(43) Pub. Date: Dec. 2, 2004

(54) Optimization of the traffic load in a communication network

(75) Inventor: Frank Ryll, Berlin (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/779,822

(22) Filed: Feb. 18, 2004

(30) Foreign Application Priority Data
Feb. 19, 2003 (DE) 103 070 05.2

(51) Int. Cl. G06F 15/16

(52) U.S. Cl. 709/232

(57) ABSTRACT

A cost-effective and efficient way of optimizing the traffic load in a communication network. A method and apparatus optimize the traffic load in a telecommunication and/or data network with a plurality of network elements which are functionally essentially independent. The presence and availability of a user of a service are taken as a basis for granting a release for a data transmission.

### CLAIM FOR PRIORITY

This application claims the benefit of priority to German Application No. 10307005.2, filed in the German language on Feb. 19, 2003, the contents of which are hereby incorporated by reference.

### TECHNICAL FIELD OF THE INVENTION

The invention relates to an apparatus and a method for optimizing the traffic load in a communication network, and in particular, to an apparatus and method having a plurality of network elements which are functionally essentially independent.

### BACKGROUND OF THE INVENTION

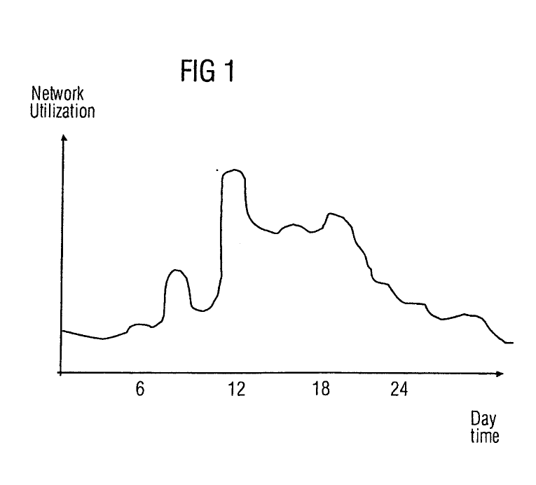

The traffic capacity of conventional telecommunication or data networks, regardless of technology/methods (e.g. POTS, ISDN, Cable TV, Broadband Internet, GSM, PCS, PHS, CDMA, TDMA, UMTS; independently of channel-oriented or packet-oriented transmission), has a utilization level which fluctuates greatly in the course of a day. At low-traffic times, sometimes more than 90% of the existing capacity is not used. One example of a typical network utilization curve as a function of time is shown in FIG. 1.

This situation has previously been remedied only by non-technical (economic) means (e.g. tariffing) which have relatively weak and undifferentiated effects, or it is accepted as given. For this reason, special tariff structures with considerable differences in charges between high-traffic and low-traffic times have been provided for a relatively long time both in the public switched telephone network (PSTN) and in the mobile radio networks. In any case, restructuring of the traffic volume can be realized only to a limited extent for normal telephony (i.e. voice links) on account of the normal daily rhythms of most people—in the private domain—and in view of normal working times—in the commercial domain. Special tariff structures of the Internet providers, which are intended to make use of the public switched telephone network attractive to the users as a data network at low-traffic times, have also addressed only relatively small groups of users and have therefore achieved only limited success.

As the network resources of the communication networks are to be used for supplementary services—partially associated with much higher bandwidth and other resource requirements—in addition to telephony, organizing a high utilization level which is as uniform as possible becomes increasingly important. A communication network can be a telecommunication network and/or data network. On the one hand, the network utilization level at the peak times limits the possible range of supplementary (particularly resource-intensive) services with respect to capacity and, on the other hand, the utilization level of the expensive infrastructure naturally plays a considerable part in determining the price of the services provided via the communication network.

It can be expected that the network utilization level will be optimized in the next few years through the selective use of particular applications. These may be applications which have specific usage times (e.g. erotica contents), are accessible only at particular times (e.g. horoscopes, diary applications) or utilize cheaper tariffs at low-traffic times (e.g. sending faxes at night). Like economic optimization by means of cheaper usage prices at low-traffic times (e.g. during the night), this type of optimization may well lead to the goal.

When the possibilities of this optimization of the network utilization level by means of applications made selectively dependent on usage time, and special tariff structures, have been largely exhausted, there will be an increasing demand for technical solutions for increasing the mean network utilization level.

### SUMMARY OF THE INVENTION

The invention provides an arrangement and a method which makes a significant contribution to increasing the mean utilization level of telecommunication or data networks.

In one embodiment of the invention, the presence and availability of a user of a service are taken as a basis for granting a release for a data transmission. This can be done, by way of example, by virtue of a presence server in a telecommunication network checking the presence and availability of a user of a service and forwarding the result to an evaluation and decision unit. The evaluation and decision unit grants further network units a release for the data transmission only if it has a positive check result available. This means that network resources are not unnecessarily engaged or loaded. The specified arrangement and the proposed method are suitable for more rapid and more precise control of the network utilization level. This more rapid and more precise form of optimizing the network utilization level of telecommunication networks allows higher network utilization coefficients to be achieved which, for their part, result in an increased return on investment for the network operators. This makes the proposed method suitable for obtaining a considerably higher return on investment when operating telecommunication networks (and possibly lower service prices for the customers).

### BRIEF DESCRIPTION OF THE INVENTION

The invention is explained in more detail using exemplary embodiments which are illustrated in the figures, in which:

FIG. 1 shows an example of a typical network utilization curve as a function of time.

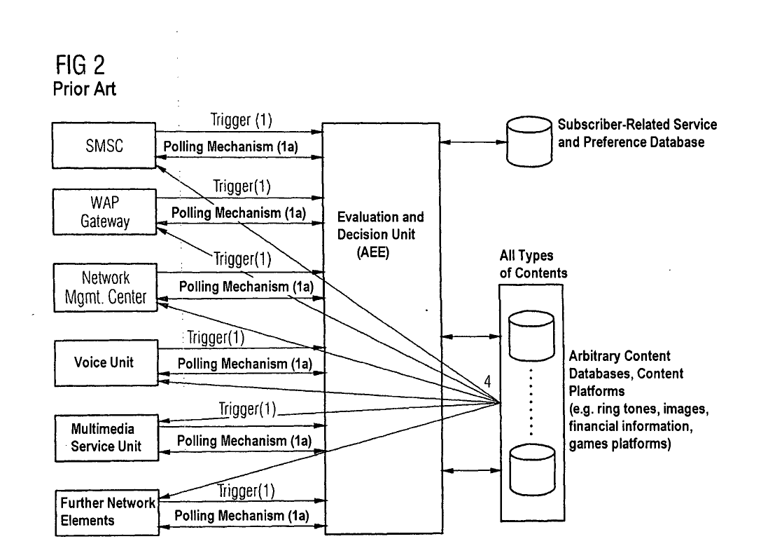

FIG. 2 shows the prior art using a greatly simplified telecommunication network structure.

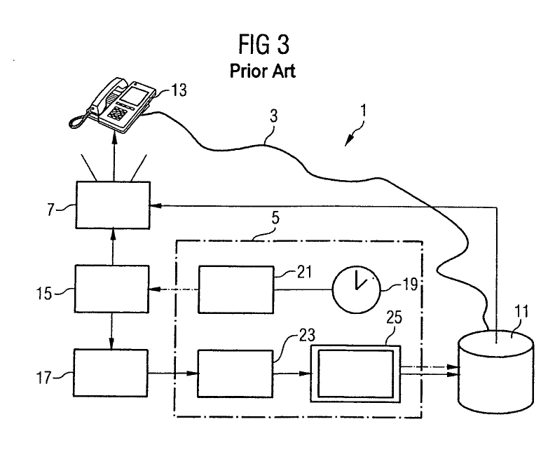

FIG. 3 shows the prior art using a function block diagram.

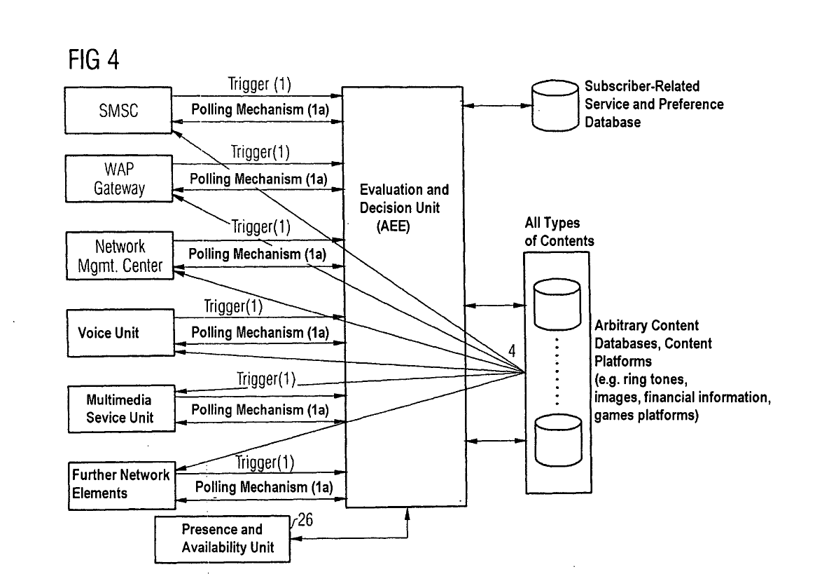

FIG. 4 shows a function block diagram with the fundamental components of a preferred embodiment of the invention's optimization arrangement.

### DETAILED DESCRIPTION OF THE INVENTION

FIG. 1 shows an example of a typical network utilization curve as a function of time.

FIG. 2 shows the prior art using a greatly simplified telecommunication network structure. The labeling makes the figure fundamentally self-explanatory, which means that a complete description is not given below, but rather reference is made only to aspects which are worth highlighting.

All relevant network elements (e.g. SMSC, WAP gateway, multimedia service unit) and also network management and control units (e.g. network management center=NMC) either send traffic-dependent triggers (subsequently also referred to as “load messages”) to the evaluation and decision unit AEE or are polled for the traffic status by the AEE.

Depending on the service-specific traffic load, the AEE, having evaluated the service and subscriber databases, will send content databases or platforms such control information as prompts said content databases or platforms to send information to the users of such services.

Fundamental aspects of the method and of the arrangement are as follows:

single-stage or multistage triggers which are sent to the AEE by various network elements or network monitoring and network control units,

interfaces on the network elements which allow the traffic status to be polled by the AEE,

the AEE, which is connected to the network elements or network monitoring and network control units and which is also

connected to various databases, e.g. subscriber and content databases or platforms, in order to poll these devices for data and to send them event-controlling information.

The AEE is controlled by service-specific algorithms whose input parameters received are the time and, inter alia, data from the aforementioned databases or from the platforms. As the result of the assessment of these parameters, the AEE will send control information to the databases or platforms which prompts the latter to send information to one or more service users (subscribers) in order to galvanize them for the further service usage which immediately follows. Thus, the AEE collaborates with the content databases or platforms for the purpose of increasing the utilization level of network elements with little loading directly by selective content transmission to the users or indirectly using an activity which increases the traffic volume and which comes from the users.

In a first important application of the proposed arrangement and of the corresponding method, the communication network comprises a cellular mobile radio network, and, as network elements, at least one SMSC and/or one WAP gateway and/or one network management center and/or one voice unit and/or one multimedia service unit are monitored and controlled with regard to their utilization level.

An application of no less importance in perspective relates to fixed networks, particularly broadband, narrowband or telephony cable networks, with the relevant network elements of network management center and/or voice unit and/or multimedia service unit and/or access points for telecommunication and data services.

If all currently conceivable types of applications with the solution proposed in the prior art are to be included within the context of optimizing the network utilization level in a solution which is universal to the greatest possible extent, all design features described are necessary. However, the optimization can also be performed only for some applications (e.g. only for online games). This reduces the implementation complexity since only these applications need to receive information from the evaluation and decision unit AEE. If only a few network elements need to be included in the optimization, then only these units send triggers to the AEE.

The method proposed in the prior art is clearly superior to the non-technical (economic) optimization of the network utilization level with regard to

speed,

granularity of the control (smaller utilization gaps can be optimized),

adaptability (response to unforeseen events, rapid fluctuations in the network load, partial failure of the telecommunication network),

inclusion of user data (e.g. initial use of the application versus later use),

return on investment for the network operator and the application provider.

It allows quasi-dynamic control, particularly increase, of the traffic utilization level of telecommunication networks.

Sending the aforementioned information is possible at neutral cost for the operator(s), since the infrastructure required for this (network elements, management and control facilities etc.) already exists and, as a rule, is currently subject to an uneconomically low usage.

FIG. 3 shows, in the manner of a function block diagram, fundamental components of a preferred embodiment of an arrangement from the application from Siemens AG with file reference EP 02000122.8 in a telecommunication network 3. The telecommunication network 3 has a central network operation control unit 5 which—inter alia—is designed for controlling as high a network utilization level as possible (and the operation of which is also described only to this extent here). In the example shown, the network operation control unit 5 communicates with a network element 7 in order to detect the traffic load thereof, and with a games database 11 in order to provide the latter's contents for a user on a telecommunication terminal 13 at a data rate which is set on the basis of the network utilization level. (In reality, a network structure in which the application of the invention is appropriate comprises a plurality of network elements to which a multiplicity of telecommunication terminals is connected and, normally, also a plurality of content databases or platforms for providing the telecommunication terminals with information or communication resources).

The network element 7 has an associated traffic load monitoring unit 15 for detecting the current traffic load, which, in turn, is connected to a load message transmission unit 17 for transmitting a load message, containing the corresponding information, to the network operation control unit 5. The operation of the traffic load monitoring unit 15 is controlled from the network operation control unit 5, which, for this purpose, has a timer 19 and a trigger signal transmission unit 21, connected to the later, for transmitting a trigger signal which initiates a respective detection process. In the network operation control unit, the load message passes to a load data reception unit 23 and from this—in suitably conditioned form—to an evaluation and decision unit 25. As the result of an evaluation, the evaluation and decision unit generates, in line with a predetermined algorithm, a control message which is transmitted to the games database 11. This causes actuation of the transmission of a predetermined information message to the telecommunication terminal 13 via the network element 7. This information message itself or a communication process which it initiates and which the user of the terminal 13 triggers prompts suitable control of the network load on the network element 7 on the basis of the load currently established for the latter. Examples of such control processes are outlined below.

In future, games, videos, music and photos will be transmitted in a UMTS network, for example. The method described will make it possible for many of these applications to be

a) arranged (see example below),

b) activated (e.g. data delivery for a further games level),

c) adapted in the degree of difficulty or the representation,

d) ended or restricted, on the basis of the network utilization level.

The following options are obtained for games:

degree of difficulty is controlled by network utilization level,

bonus games are controlled by network utilization level,

actions in the games are controlled by network utilization level (e.g. opponent attacks),

specific properties are controlled by network utilization level,

SMSs used for continuing the game are controlled by network utilization level.

The following options are obtained for SMSs:

invitations are sent under the control of network utilization level,

advertising is sent under the control of network utilization level,

invitations for playing games are controlled by network utilization level.

The following options are obtained for mobile commerce:

vouchers are sent under the control of network utilization level,

coupons are sent under the control of network utilization level.

For information/infotainment, the following are obtained, for example:

horoscopes are sent under the control of network utilization level,

weather reports are sent under the control of network utilization level.

### Example Scenario 1

Simulation game in the World Wide Web (WWW) which is controlled primarily by a WWW interface (Web browser) and secondarily by SMS (mobile part) and by the user. The simulation game is running continuously in the WWW and can send and receive SMSs.

Call by end user: 9.45 pm Sunday, access via Web browser.

User starts exploring three strange planets from a space station.

Call by end user: 9.10 am Monday, access via Web browser.

User starts settlement on two of the three strange planets.

Call by network-load-dependent trigger (mobile radio network <20% network utilization level for SMS): 11.45 am Monday, sending of SMS by the application. SMS content: there has been an earthquake on one of the planets.

11.49 am Monday:

User sends SMS/uses WAP access: initiate rescue work. Call by network-load-dependent trigger (mobile radio network <20% network utilization level for SMS): 1.55 pm Monday, sending of SMS by the application. SMS content: there has been another earthquake on one of the planets.

2.10 pm Monday:

User sends SMS/uses WAP access: initiate evacuation of the planet.

Call by end user: 9.45 pm Monday, access via Web browser.

User transfers all people to other planets and starts new planet exploration.

### Example Scenario 2

Motor racing game, transmission via UMTS, task: controlling a racing car.

First call by end user: 9.45 pm Sunday, 20% network utilization level.

AEE sends corresponding triggers, stores usage.

Setting: day. Resolution: high. Environment: spectators can be seen, animated, the hair of the spectators is blowing about in the wind.

Second call by end user: 12.45 pm Wednesday, 80% utilization level.

AEE sends corresponding triggers, stores usage.

Setting: fog. Resolution: low. Environment: only the track is visible, the rest is lost in the fog.

Third call by end user: 11.11 pm Wednesday, 10% network utilization level. AEE sends corresponding triggers, stores usage.

Setting: day. Resolution: very high. Environment: spectators, high resolution. In addition, bonus rounds are issued.

Fourth call by end user: 3:55 pm Thursday, 90% network utilization level.

AEE sends corresponding triggers, stores usage.

Setting: night. Resolution: very low. Environment: only the light beams from the car can be seen, the rest remains in the darkness of night.

FIG. 4 shows a function block diagram with fundamental components of a preferred embodiment of the invention's optimization arrangement. All relevant network elements (e.g. SMSC, WAP-GW, multimedia service unit) and also network management and control units (e.g. network management center, NMC) either send traffic-dependent triggers 1 to the evaluation and decision unit (AEE) 25 or are polled for the traffic status la by the AEE. Depending on the service-specific traffic load, the AEE 25, having evaluated the service and subscriber databases, will send content databases and platforms such control information as prompts the latter to poll the presence and availability unit (PVE) 26 for which of the service users is currently present (is technically able to receive these data) and available (is fundamentally willing to use these data for himself). When this has been established, the information is sent to the ascertained users of such services. In this case, it is likewise possible for this establishment of status with the PVE 26 to be performed by the AEE 25 as well. The evaluation and decision unit AEE 25 communicates with a presence and availability unit PVE 26 on the basis of control data received from the telecommunication network or service use profiles, preferences etc. which have been set by users. A presence and availability unit PVE 26 can, by way of example, be an IMS presence server in a mobile telecommunication network. If, by way of example, 100 000 coupons need to be sent to users but the current network capacity allows only 80 000 users to be addressed, then the inventive method and the apparatus can be used to ascertain the users who are present and available. This allows the network load to be minimized by virtue of a coupon being sent only to the users who are actually present and available. This is done by virtue of network information or control data being used by a presence and availability unit PVE 26 to ascertain which users are present and available, and said presence and availability unit transmitting the check result to the AEE. There, a release for the data transmission of other network units is given only for the, e.g. currently 51 287, users who are present and available. This ensures that these data reach the user in question.

What is claimed is:

1. A method for optimizing traffic load in a communication network comprising a plurality of network elements which are functionally, essentially independent, wherein presence and availability of a user of a service are taken as a basis for granting a release for a data transmission.

2. The method as claimed in claim 1, wherein the presence and availability of the user of the service are checked using a presence server.

3. The method as claimed in claim 1, wherein the presence and availability of the user of the service are checked using control data in a telecommunication network.

4. The method as claimed in claim 1, wherein the presence and availability of the user of the service are checked using at least one service use profile including profile data.

5. The method as claimed in claim 1, wherein a positive check result is taken as a basis for an evaluation and decision unit to release a data transmission to the user of the service.

6. The method as claimed in claim 1, wherein
at least one network element has the traffic load detected for it,
timer signals, external trigger signals or a result of a comparison with preprogrammed threshold values is/are taken as a basis for creating load messages for signaling the traffic load and sending them to a network operation control unit,
the load messages are received and evaluated by the network operation control unit, and
control signals to selected content databases or platforms relating to the transmission of predetermined contents or other information to users' telecommunication and data terminals connected to selected network elements are generated in relation to the evaluated load messages.

7. The method as claimed in claim 6, wherein the network operation control unit transmits trigger signals to the network elements for generating and/or transmitting load messages.

8. The method as claimed in claim 6, wherein the network elements have the threshold values relating to the traffic load programmed for them which are used for a comparison which triggers the transmission of load messages.

9. The method as claimed in claim 6, wherein control signals are output to selected content databases or platforms in relation to at least one service use profile for the users which includes prestored profile data.

10. An apparatus for optimizing traffic load in a communication network, comprising:
a plurality of network elements which are functionally, essentially independent; and
a first unit which is configured such that it checks whether a user of a service is present and available and forwards the check result to a second unit, the second unit configured such that it evaluates the check result and, if the check result is positive, makes a decision to release a data transmission to a present and available user of the service.

11. The apparatus as claimed in claim 10, wherein the second unit is configured as an evaluation and decision unit.

12. The apparatus as claimed in claim 10, wherein the first unit receives data for checking other network units.

13. The apparatus as claimed in claim 10, wherein the first unit is configured as a presence server.

14. The apparatus as claimed in claim 10, further comprising:
a network operation control unit including, for receiving load messages from at least some of the network elements; and
a load data reception unit which is connected to an evaluation and decision unit for evaluating the load messages and for outputting control signals in relation to message content to selected content databases or platforms.

15. The apparatus as claimed in claim 10, wherein content databases and/or platforms are designed to respond to control signals for transmitting predetermined contents or other information to users' telecommunication or data terminals connected to selected network elements.

16. The apparatus as claimed in claim 14, further comprising traffic load monitoring units or load message transmission units associated with the network elements including timers for actuating detection of the traffic load and/or transmission of the load message to the network operation control unit at predetermined times or at predetermined time intervals.

17. The apparatus as claimed in claim 14, wherein at least some of the network elements are provided with traffic load monitoring units and load message transmission units, connected to the latter, for transmitting load messages which signal the respective network element's traffic load to the network operation control unit.

18. The apparatus as claimed in claim 17, wherein the traffic load monitoring units have discriminator units which are configured such that they continuously compare a detected traffic load with threshold values and actuate transmission of the load message if the threshold values are exceeded and/or undershot.

19. The apparatus as claimed in claim 16, wherein for requesting load messages from the traffic load monitoring units, an evaluation and decision unit in the network operation control unit includes a timer and a trigger pulse transmitter for generating and transmitting trigger pulses.
